(19) United States
(12) Patent Application Publication
(10) Pub. No.: US 2011/0311795 A1
(43) Pub. Date: Dec. 22, 2011

(54) THERMALLY FUSIBLE INTERLINING NONWOVEN AND PRODUCTION AND USE THEREOF

(75) Inventors: Heike Bartl, Weinheim (DE); Oliver Staudenmayer, Weinheim (DE); Thomas Kühlwein, Laumersheim (DE)

(73) Assignee: CARL FREUDENBERG KG, Weinheim (DE)

(21) Appl. No.: 13/254,212

(22) PCT Filed: Jan. 16, 2010
(86) PCT No.: PCT/EP2010/000228

§ 371 Date: Sep. 1, 2011

(30) Foreign Application Priority Data
Mar. 25, 2009 (DE) 10 2009 014 290.8

(51) Int. Cl. D04H 1/54; B32B 27/12; D04H 13/00; B32B 27/02

(52) U.S. Cl. 428/219; 442/381; 428/221; 156/148

(57) ABSTRACT

A thermally fusible interlining nonwoven includes a fusing layer (A) having at least one staple fiber nonwoven containing at least 50% by weight of thermoplastic staple fibers having at least one of a melting or softening temperature in a range from 60° C. to 165° C. A layer (B) is bonded together with layer (A) and includes at least one staple fiber nonwoven or a staple fiber nonwoven fabric having staple fibers. At least 80% by weight of the staple fibers of layer (B) have at least one of a softening temperature, melting temperature and degradation temperature that is higher than or equal to 170° C.

### CROSS REFERENCE TO RELATED APPLICATIONS

This application is a U.S. National Phase application under 35 U.S.C. §371 of International application No. PCT/EP2010/000228, filed on Jan. 16, 2010, and claims benefit to German patent application No. DE 10 2009 014 290.8, filed on Mar. 25, 2009. The International application was published in German on Sep. 30, 2010 as WO 2010/108562 A1 under PCT Article 21 (2).

### FIELD OF THE INVENTION

The invention relates to a thermally fusible interlining nonwoven as well as to a method for its production and to its uses.

### BACKGROUND

Thermally fusible interlinings are used primarily in applications in the realms of clothing, automobiles, furniture, home furnishing textiles, and hygiene products. They are usually textile fabrics such as, for example, wovens, knits, nonwovens or felt with applied melt adhesives which, through exposure to temperature, heat and time, produce a permanently adhering bond, usually to textile substrates such as shell fabrics. The adhesion brings about a stabilization and/or shaping of the substrate. The strength of the bond between the textile substrate and the interlining material is referred to as the delamination force. For the application in question, it is generally desired to achieve a strong and permanent bond between the interlining material and the textile substrate, and thus a good delamination force. Consequently, the bond in an article of clothing fused to interlining material should still be intact, even after care treatments such as, for example, household laundering.

Moreover, for use in clothing, there is often a need for interlining materials that have a low level of back-tacking. The term back-tacking refers to instances in which the melt adhesive soaks through the textile fabric onto which it has been applied during thermal fusion to the textile substrate.

Thermally fusible interlining nonwovens normally consist of a backing material made by the conventional methods of nonwoven production, normally a staple fiber nonwoven fabric onto which thermoplastic melt adhesive is applied (coated) as the bonding compound. Such methods are described, for example, in “Handbuch der textilen Fixiereinlagen” (Manual of Textile Fusing Interlinings), by Prof. Dr. P. Sroka, 3^{rd} expanded edition 1993; published by Hartung-Gorre Verlag, Constance, Germany, pp. 95-161.

The melt adhesive polymers normally used for fusing interlinings include synthetic thermoplastic polymers such as copolyamides, copolyesters, polyolefins, ethylene-vinylacetate-copolymers or polyurethanes. These are normally applied in the form of a paste and/or a powder, as an organosol or a plastisol or a melt onto the nonwoven backing material, then dried and bonded to the nonwoven by thermal sintering. Commonly employed methods for applying melt adhesive polymers are paste printing, powder-dot or double-dot methods.

After the textile backing material has been produced, the thermoplastic melt adhesive polymer is applied by means of at least one application unit designed for this purpose. The application unit for the melt adhesive polymers is usually separate from the installation that produces the textile fabric, so that the melt adhesive polymer is applied in an additional process step that takes place after the fiber has been laid. Thermally fusible interlining (nonwoven) materials or fusible interlining materials, melt adhesive polymers and associated application methods are described, for example, in the “Handbuch der textilen Fixiereinlagen” (Manual of Textile Fusing Interlinings), by Prof. Dr. P. Sroka, 3^{rd} expanded edition 1993; published by Hartung-Gorre Verlag, Constance, Germany, pp. 7-400.

When used as a thermally fusible interlining nonwoven, the melt adhesive is melted under the effect of heat and pressure. In this manner, the interlining nonwoven is glued on the side that is coated with melt adhesive, usually onto one side of a textile shell fabric. The process of adhering the interlining nonwoven to the textile shell fabric (fusing) is carried out according to the state of the art under exposure to heat and, if applicable, under pressure over a prescribed period of time. These parameters are freely selectable within certain limits that are known to the person skilled in the art. Thus, in order to avoid thermal damage to the textile shell fabric, the fusing temperatures employed during the adhesion to the fusible interlining nonwoven are usually in the range from 60° C. to 165° C., in rare cases up to 200° C. As a rule, the fusing temperature is set in such a way that it is at or slightly above the melting and/or softening temperature of the melt adhesive being used in a given case, so that the melt adhesive adheres to the textile shell fabric. It has been found that, in general, when the melt adhesive reaches the softening temperature, it is already sufficiently tacky in order to permit gluing to the shell fabric.

The fusing time during which the exposure to heat takes place is usually in the range from 5 seconds to 120 seconds. The pressure is generally in the range from 0 N/m² to 8×10⁵ N/m². The fusing is carried out according to the state of the art by means of fusing aggregates that can be, for example, presses (through-feed pressing machines or plate pressing machines), or else hot irons. The parameters relevant for the fusing process (temperature, time, pressure, aggregate) are referred to as the fusing conditions.

If the melt adhesive is applied to both sides of the nonwoven, the interlining thus produced can be glued onto both sides of textile shell fabrics. However, thermally fusible interlining nonwovens are far less frequently glued onto both sides of textile shell fabrics.

A drawback of the prior-art thermally fusible interlining nonwovens is that their production involves a high reject rate. The reason for this lies in irregularities in the application of the adhesive, which can cause adhesion flaws. Adhesion flaws are places on the backing material where insufficient adhesive or no adhesive at all has been applied. In actual use, these places become visible as blisters and, if they are subjected to a certain amount of stress, they can cause the nonwoven to be detached from the textile shell fabric. In order to avoid these problems, adhesion flaws are normally detected by a visual inspection, then marked in order to prevent the product from being used, or else they are sorted out by being cut away and subsequently discarded as waste, which involves costs and burdens the environment.

There are many different causes for an irregular application of the melt adhesive. Thus, for example, fluctuations in the thickness and/or weight of the backing material can lead to an irregular absorption of the melt adhesive. Whereas a larger amount of melt adhesive can accumulate at places where the backing material is heavier or thicker, less melt adhesive is located at the thin places.

Another cause for an irregular application of the melt adhesive is distortions in the nonwoven backing material. If the width of nonwoven fabric passes through the melt adhesive application unit at differing tensions because of distortions, creases can easily form at the places where the material tension is lower. There, little or no melt adhesive is transferred in comparison to areas with a higher material tension. Distortions stem from the process itself and cannot be prevented during the production of nonwovens.

Finally, irregularities such as soiling of the application unit, agglomeration and non-homogeneity of the melt adhesive polymers as well as electrostatic charging also cause an irregular application of the melt adhesive onto the nonwoven.

Another drawback of the prior-art thermally fusible interlining nonwovens is that, especially in case of thin shell fabrics that are less than 0.35 mm thick or that have an interrupted (perforated) material structure, the adhesive compound can show through on the outside of the shell fabric after the gluing procedure, for example, in the form of elevations that are visually and haptically perceptible, or else the melt adhesive can pass through to the outside of the textile shell fabric that is not glued to the interlining nonwoven, where it can be felt and/or seen, for example, in the form of elevations. As a rule, the results are quite unsatisfactory when such thin or perforated textile shell fabrics are fused to the conventional thermally fusible interlining nonwovens.

As explained in the “Handbuch der textilen Fixiereinlagen” (Manual of Textile Fusing Interlinings), by Prof. Dr. P. Sroka, 3^{rd} expanded edition 1993; published by Hartung-Gorre Verlag, Constance, Germany, Chapter 6.12, pp. 146-152, adhesive nets were offered for a short time as a substitute for fusing interlinings; these adhesive nets could be sealed on the net side but were adhesively inactive on the other side. Such nets are made up of uninterrupted webs. However, these nets were not a success since, after the fusing process, the hand was too stiff and the volume was too flat.

### SUMMARY

In an embodiment, the present invention provides thermally fusible interlining nonwoven including a fusing layer (A) having at least one staple fiber nonwoven containing at least 50% by weight of thermoplastic staple fibers having at least one of a melting or softening temperature in a range from 60° C. to 165° C. A layer (B) is bonded together with layer (A) and includes at least one staple fiber nonwoven or a staple fiber nonwoven fabric having staple fibers. At least 80% by weight of the staple fibers of layer (B) have at least one of a softening temperature, melting temperature and degradation temperature that is higher than or equal to 170° C.

### BRIEF DESCRIPTION OF THE DRAWINGS

Examples and embodiments of the invention are described in detail below along with a description with reference to the drawings, in which:

FIG. 1 shows a standard nonwoven interlining, described in Example 11A below, fused onto a shell fabric with a perforated material structure;

FIG. 2 shows the interlining nonwoven according to an embodiment of the invention from Example 11, fused onto the same shell fabric.

### DETAILED DESCRIPTION

An aspect of the invention is to provide an interlining material that can be thermally fused on one side, that has good visual and haptic properties, that has a good and uniform adhesive strength, that, if required, has a low level of back-tacking, and that can be produced in a simple and inexpensive manner. The interlining nonwoven should especially be useable even for thin substrates or for those with a perforated material structure. Moreover, a broad range of interlining nonwovens with differing hand properties should be provided, that is to say, interlining materials with a stiffer or softer hand.

This aspect can be achieved by a thermally fusible interlining nonwoven, embodiments of which are described in detail below, or a method for the production of a thermally fusible interlining nonwoven.

A thermally fusible interlining nonwoven according to an embodiment of the invention is characterized in that it comprises a fusing layer (A) made of at least one staple fiber nonwoven that contains at least 50% by weight of melted and/or not melted thermoplastic staple fibers whose melting and/or softening temperature is in the range between 60° C. and 165° C., as well as a layer (B) made of at least one staple fiber nonwoven or a staple fiber nonwoven fabric consisting of staple fibers, at least 80% by weight of the staple fibers having a softening and melting temperature or, if no such temperature is applicable, having a degradation temperature that is higher than or equal to 170° C., and said layers (A) and (B) being bonded together.

The values given as a percentage by weight (% by weight) relate here to the weight of the individual layer (A) or layer (B).

Preferably, the staple fibers comprising at least 50% by weight of layer (A) and having a melting and/or softening temperature between 60° C. and 165° C. differ by at least one chemical building block from the staple fibers comprising 80% to 100% by weight of layer (B) and having a softening and melting temperature or, if no such temperature is applicable, having a degradation temperature of more than 170° C.

The thermally fusible interlining nonwoven according to the embodiment described above, in contrast to the melt adhesive-coated fusing interlinings according to the state of the art, does not involve the application of an additional melt adhesive, for example, onto the backing material surface and furthermore, aside from the thermoplastic staple fibers, said thermally fusible interlining nonwoven does not have any additional components that—during the adhesion onto textile substrates under the normal fusing conditions, that is to say, temperatures of up to 200° C., a fusing time of 5 seconds to 120 seconds, a pressure of 0 N/m² to 8×10⁵ N/m²—would become active as an adhesive vis-à-vis the textile substrate and would result in a measurable adhesion/delamination force, as measured according to DIN 54310:1980. The adhesive effect is achieved exclusively by the thermoplastic staple fibers in layer A. This is all the more astonishing since the person skilled in the art would expect that, after being fused to textile substrates, the nonwoven obtained after layers A and B have been bonded together would have inadequate adhesive strength and excessive back-tacking.

Thus, the person skilled in the art would expect that the thermoplastic staple fibers of layer A would no longer remain in layer (A) in a sufficient amount to produce a firm adhesive bond when layers (A) and (B) are bonded together, or else that, when the thermoplastic staple fibers are bonded together, a large number of the fibers would be transferred to the surface of layer (B), resulting in an inadequate delamination force and a high level of back-tacking.

By the same token, the person skilled in the art would expect that, when such a nonwoven is fused to a textile substrate in the usual fusing range, such a strong adhesion of the staple fibers of layer (A) to each other and/or to the staple fibers of layer (B) would be achieved that, when such nonwovens are fused, there would no longer be an adequate adhesive effect/delamination force vis-à-vis the textile substrates.

Since the thermoplastic staple fibers used in layer (A)—unlike the melt adhesives that, according to the state of the art, are generally applied onto the backing in the form of dots—can change in length and can shrink under exposure to heat, it is all the more surprising that, with an interlining produced according to the an embodiment of invention, a fused textile substrate can be obtained that has a uniform appearance and haptics as well as a smooth surface.

During the normal thermal bonding processes, for example, during calendaring, which is generally carried out at temperatures above the melting temperature of the above-mentioned thermoplastic staple fibers of layer (A), it can also be expected that the thermoplastic staple fibers of layer (A) will melt and, for example, remain adhering to the calendaring rollers, as a result of which layer (A) becomes irregular, or that the staple fibers will migrate into layer (B), so that an inadequate amount of thermoplastic material remains for the adhesion of layer (A) to the textile substrate.

By the same token, if a needling process were to be used such as, for instance, a water-jet needling process, one would expect that the thermoplastic staple fibers would be mixed too much with the staple fibers of layer (B) or would migrate into layer (B), since relatively high water jet pressures have to be used to create a sufficiently strong bond between layers (A) and (B). However, in a surprising manner, it has been found that an interlining nonwoven according to the an embodiment of invention that has been bonded by means of a water jet treatment also has a very good adhesive strength after having been fused to a textile substrate.

Under normal fusing conditions, the interlining nonwovens according to the an embodiment of invention have not only a sufficiently good and durable adhesive strength and, if necessary, a low level of back-tacking, but even when they are adhered to textile shell fabrics of the usual thickness, they do not soak through on the outside of the textile substrate which has not been fused to the interlining nonwoven and are thus not visible there, as a result of which the fused shell fabrics have a very uniform appearance. In addition, within the areas fused to the interlining nonwoven, no appreciable differences in the hand can be felt, so that very uniform haptics are achieved with the interlining nonwovens. Surprisingly, this holds true even for thin textiles or perforated shell fabrics for which the interlining nonwoven likewise yields a uniform appearance and feel.

As used herein, the term “thermally fusible interlining nonwoven” refers to a nonwoven that is suited and intended to be bonded with sufficient adhesion to one side of a textile substrate via its fusing side.

The thermally fusible interlining nonwovens according to embodiments of the invention are characterized by a sufficiently good adhesion. Such a good adhesion is said to exist if, after the thermal fusion under conventional fusing conditions (temperature, pressure, time, aggregate), the textile substrate bonded to the fusing interlining yields delamination force values of at least 3 N in a delamination force test according to DIN 54310:1980, with deviations in the sample size (test sample: 150 mm×50 mm, test material: 160 mm×60 mm) and a drawing-off speed of 150 mm/min, using a fusing press of the type Kannegiesser CX 1000 or Gygli Top Fusing Mod. PR 5/70 with a suitable textile substrate. As can be seen below with reference to the embodiments, the thermally fusible interlining nonwovens exhibit delamination force values of well above 3 N. A delamination force measured after the fusing, that is to say without any further treatment such as household laundering, is often referred to as primary adhesion. Permanent adhesion is said to exist if, after at least one household laundering cycle according to EN ISO 6330:2000 (method no. 2A, 60° C.), the fused substrate still exhibits a delamination force value of at least 1 N. This value, as can be seen in the table below, is also clearly surpassed in the embodiments according to the invention.

Layers (A) and (B) are preferably made of one or more dry-laid staple fiber nonwovens. As an alternative, a dry-laid staple fiber nonwoven fabric can also be used in order to produce layer (B). Staple fiber nonwovens and staple fiber nonwoven fabrics, especially in light weight classes of less than 100 g/m², of the type predominantly used for interlining nonwovens, are characterized by a very uniform weight and thickness distribution and a continuous surface. Moreover, the hand of staple fiber nonwovens and staple fiber nonwoven fabrics can be varied flexibly since numerous degrees of freedom are available when it comes to selecting the hand, namely, the length of the staple fibers, the orientation of the fibers in the staple fiber nonwoven or staple fiber nonwoven fabric, and the simple option of mixing various types of fibers (fiber polymers) in the staple fiber nonwoven.

According to the an embodiment of invention, fusing layer (A) and layer (B) as well as the interlining nonwoven made thereof contain—as the fibers—exclusively staple fibers of a specified and limited length, but no continuous fibers (filaments).

The terms staple fiber, continuous fibers, staple fiber nonwoven and nonwoven are used in the sense of the definitions specified in DIN 60000 (January 1969). Staple fibers as set forth in the present invention are thus fibers of limited length, whereas continuous fibers (filaments) are fibers of practically unlimited length. In this patent application, the term staple fiber is used in the manner put forward by J. Lünenschloss, W. Albrecht, in “Vliesstoffe” [Nonwovens], published by Georg Thieme Verlag Stuttgart, New York, 1982 Chapter 1.2., FIG. 0.1, p. 3 for synthetic and natural fibers, that is to say, for synthetically, semi-synthetically produced fibers and natural fibers. The terms staple fiber nonwoven and staple fiber nonwoven fabric are used in the manner put forward by J. Lünenschloss, W. Albrecht, in “Vliesstoffe” [Nonwovens], published by Georg Thieme Verlag Stuttgart, New York, 1982, p. 106f and p. 68f.

The staple fiber nonwoven or staple fiber nonwovens that yield fusing layer (A) contain up to 50% to 100% by weight of staple fibers made of a thermoplastic material (thermoplastic staple fibers), and the melting and/or softening temperature of the thermoplastic staple fibers is between 60° C. and 165° C. This ensures that, under the normally employed, above-mentioned fusing temperatures, they become sufficiently tacky to create a firm adhesive bond to the shell fabric. If the fraction drops below 50% by weight, the adhesive strength diminishes too much.

Thermoplastic staple fibers are characterized in that, like thermoplastics, they can be deformed within a certain temperature range. This process is reversible, that is to say, it can be repeated by cooling the material off and heating it up again, as long as no thermal degradation of the material occurs due to overheating. In this manner, thermoplastics differ from thermosetting plastics and elastomers.

The softening temperature (glass transition temperature Tg) refers to the temperature at which a polymer changes from the brittle, energy-elastic range (T<Tg) to the soft entropy-elastic range (T>Tg). Semi-crystalline plastics such as thermoplastic staple fibers have a glass transition temperature as well as a melting temperature at which the crystalline phase dissolves and the polymer changes into the liquid state. The glass transition temperature of staple fibers can be determined according to ISO 11357-2:1999-03. The melting temperature of staple fibers can be determined according to ISO 3146:2002-06. The softening and melting temperature of thermoplastic staple fibers often extends over a more or less wide range so that frequently, temperature ranges are given. Consequently, the term softening and melting temperature in the present explanation is used in such a way that it can also refer to a temperature range.

The degradation temperature is the temperature or the temperature range above which a material irreversibly changes its chemical structure and thus degrades.

According to a preferred embodiment of the invention, layers (A) and (B) can be visually and/or haptically distinguished by a person skilled in the art. Preferably, as will still be described below, the method for producing and/or bonding the layers (A) and (B) is carried out in such a way as to ensure that they can be visually and/or haptically distinguished, and no further method steps are needed to establish the possibility of distinguishing them.

According to an embodiment of the invention, layer (B) consists of up to 80% to 100% by weight of staple fibers whose softening and melting temperature or, if no such temperature is applicable, whose degradation temperature is higher than or equal to 170° C. This ensures that layer (B) remains thermally stable at the normally employed fusing temperatures. If applicable, however, the length of the staple fibers of layer (B) can change (thermally shrink) at or below 170° C.

After the nonwovens have been fused to suitable textile substrates under conventional fusing conditions, they exhibit delamination force values of at least 3 N, as measured according to DIN 54310:1980, with deviations in the sample size (test sample: 150 mm×50 mm, test material: 160 mm×60 mm) and a drawing-off speed of 150 mm/min, using a fusing press of the type Kannegiesser CX 1000 or Gygli Top Fusing Mod. PR 5/70.

The nonwovens have maximum tensile force values in the lengthwise direction (fabric running direction during the production of the nonwovens) of at least 3 N, as measured according to DIN EN 29073-03:1992, with deviations in the drawing-off speed (200 mm/min).

In the nonwovens according to embodiments of the invention, the maximum tensile forces are a measure of the hand properties. The lower the maximum tensile forces are, the softer the hand. If the maximum tensile forces are in the range below 3 N, then the nonwovens can no longer be handled and would too easily tear or be destroyed during use. Correspondingly, the maximum tensile forces that result after the fusing interlining has been fused to the textile substrate are a measure of the hand of the fused textile substrate.

If necessary, low levels of back-tacking in the range from 0 N to 3 N, especially <1 N or 0 N, can be set in textiles that have been provided with the fusing interlinings according to embodiments of the invention. In this case, the back-tacking is measured according to DIN 54310:1980, with deviations in the sample size (test sample: 300 mm×100 mm, test fabric: 300 mm×110 mm) and a drawing-off speed of 150 mm/min, and a measuring distance of 50 mm, using a fusing press of the type Kannegiesser CX 1000 or Gygli Top Fusing Mod. PR 5/70. The levels of back-tacking often have to be kept low in actual practice so as to prevent the adhesive medium from soaking through the nonwoven backing and so as to avoid subsequent problems such as sticking of the layers when several interlining materials/shell fabric layers are laid over each other and fused at the same time, or else to avoid soiling of the fusing aggregate and/or excessive stiffening of the hand of the fused substrate.

According to a preferred embodiment of the invention, the interlining nonwovens make the sides (A) and (B) very easy to distinguish visually and/or haptically from each other. This is advantageous for the user when the interlining is being fused to a textile shell fabric.

The fusing interlinings according to the invention have a thickness of 0.05 mm to 30 mm Thinner as well as thicker interlining nonwovens are difficult to produce and/or to handle. Special preference is given to thicknesses between 0.05 mm and 3 mm, especially preferably between 0.1 mm and 0.6 mm, as measured according to DIN EN ISO 9073-2 (February 1997).

In a preferred embodiment of the invention, the percentage of thermoplastic staple fibers in fusing layer (A) having melting and/or softening temperatures in the range from 60° C. to 165° C., is at least 75% by weight, especially preferably 90% by weight. Especially preferably, the percentage of thermoplastic staple fibers in fusing layer (A), having melting and/or softening temperatures in the range from 60° C. to 165° C., amounts to 95% to 100% by weight. Thus, fusing layer (A) can contain up to 50%, 25%, 10%, 5% or 0% by weight of non-thermoplastic staple fibers whose melting and/or softening temperature is above 165° C.

In another preferred embodiment of the invention, fusing layer (A) contains thermoplastic two-component staple fibers or it consists thereof. The two-component staple fibers consist of fibers having a melting and/or softening temperature in the range from 60° C. to 165° C. and of fibers having a melting and/or softening temperature that is higher than 165° C. The fibers that have a melting and/or softening temperature in the range from 60° C. to 165° C. are not sheathed. The thermoplastic two-component staple fibers can have a core-sheath arrangement or a side-by-side arrangement of their components.

Preferably, layer (B) consists of at least 80%, especially preferably 90%, very particularly preferably of 95% to 100% by weight of homopolymer and/or copolymer staple fibers. The melting or softening temperature or, if no such temperature is applicable, the degradation temperature of the staple fibers of layer (B) is preferably at least 10° C., especially preferably at least 35° C., very particularly preferably at least 85° C., above the temperature of 165° C. This ensures that, when the interlining nonwoven is fused, no appreciable melting of the staple fibers of layer (B) occurs, and soiling of the fusing aggregate with melted staple fibers of layer (B) is prevented.

The staple fibers used to produce layers (A) and (B) have an average cut length of 5 mm to 150 mm, preferably 10 mm to 100 mm, especially preferably 20 mm to 50 mm.

In a preferred embodiment of the invention, the melting or softening temperature of the thermoplastic staple fibers is in the range between 75° C. and 160° C., especially preferably between 75° C. and 140° C. Melting and/or softening temperatures of 75° C. to 140° C. are achieved especially with fibers made of copolyamides, copolyesters or polyethylene.

The thermoplastic staple fibers used in layer (A) can be homopolymers or copolymers. In preferred embodiments of the invention, one or more staple fiber nonwovens of fusing layer (A) contain thermoplastic fibers of copolyamide, polyester, copolyester, polyolefin, polypropylene, polyethylene, polyvinyl acetate, ethylene vinyl acetate, polylactic acid or (ethylene)methacrylic acid or copolymers thereof.

In order to produce the staple fiber nonwoven or the staple fiber nonwovens of layer (B), all staple fibers that are thermally stable below 170° C. can be used. This means that staple fibers can be used whose softening and melting temperature or, if no such temperature is applicable, whose degradation temperature is higher than 170° C., so that no softening, melting or degradation occurs at a temperature of 170° C. or less. If applicable, however, the length of the staple fibers can change (thermally shrink) at or below 170° C. The staple fibers that are used to produce the staple fiber nonwoven, the staple fiber nonwovens or the staple fiber nonwoven fabric of layer (B) can be thermoplastic or non-thermoplastic fibers that are thermally stable below 170° C., and corresponding synthetically, semi-synthetically produced fibers or natural fibers or mixtures of these fibers can be used.

In preferred embodiments of the invention, the staple fiber nonwoven, the staple fiber nonwovens or the staple fiber nonwoven fabrics of layer (B) contain staple fibers made of polyamide, polyester, native or regenerated cellulose, m-aramid or p-aramid, melamin resin, wool or, if applicable, copolymers thereof. The staple fibers are especially selected from the group consisting of the polyesters and/or of the polyamides.

Fusing layer (A) makes up 5% to 50% by weight, preferably 10% to 40% by weight, and especially preferably 15% to 35% of the total weight of the fusing interlining, while layer (B) makes up 50% to 95% by weight, preferably 60% to 90% by weight, especially preferably 65% to 85% of the total weight of the fusing interlining.

The weight of fusing layer (A) is preferably at least 5 g/m², and that of layer (B) is preferably at least 5 g/m².

The denier of the fibers used for the production of layers (A) and (B) is between 0.5 dtex and 40 dtex, preferably between 1.0 dtex and 10 dtex, especially preferably between 1.3 dtex and 6 dtex.

The weight per unit area of the fusing interlining according to embodiments of the invention is 10 g/m² to 300 g/m², preferably 15 g/m² to 150 g/m², especially preferably 20 g/m² to 100 g/m².

A method for the production of a thermally fusible interlining nonwoven according to an embodiment of the invention comprises the following steps:
a) providing a fusing layer (A) consisting of at least one staple fiber nonwoven that has 50% to 100% by weight of melted and/or not melted thermoplastic staple fibers, or else, in the case of two-component staple fibers, corresponding melted and/or not melted thermoplastic staple fibers, whose melting and/or softening temperature is in the range between 60° C. and 165° C.,
b) providing a layer (B) consisting of at least one staple fiber nonwoven or a staple fiber nonwoven fabric that comprises 80% to 100% by weight of staple fibers whose softening and melting temperature or, if no such temperature is applicable, whose degradation temperature is higher than 170° C., and
c) bonding (C) fusing layer (A) to layer (B).

The values given as a percentage by weight (% by weight) relate here to the weight of the individual layers (A) and (B).

The production of the staple fiber nonwoven or staple fiber nonwovens of fusing layer (A) and of layer (B) of the fusing interlining according to the invention can be carried out without limiting the general applicability, by making use of the methods known to the person skilled in the art for producing dry-laid staple fiber nonwovens. These are described, for example, in Lünenschloss, W. Albrecht, “Vliesstoffe [Nonwovens]”, published by Georg Thieme Verlag Stuttgart, New York, (1982) under Chapter 2, pp. 67-105 (1. Vliesbildung [Nonwoven formation], 1.1.1. Spinnfaservliese [Staple fiber nonwovens]). The dry-laid staple fiber nonwoven fabric, which can be used as layer (B) instead of staple fiber nonwovens, can likewise be produced by means of methods known to the person skilled in the art for the production of dry-laid staple fiber nonwoven fabrics. Such methods are described, for instance, in Lünenschloss, W. Albrecht, “Vliesstoffe [Nonwovens]”, Georg Thieme Verlag Stuttgart, New York, (1982) Chapter 1.2-1.2.4 (pp. 122-225).

In order to produce a thermally fusible interlining nonwoven according to an embodiment of the invention, preferably two nonwoven-producing installations are used—which can be combing and/or carding and/or aerodynamic nonwoven-producing installations—with which at least two staple fiber nonwovens are made from appropriate nonwoven fleeces. Of these, at least one staple fiber nonwoven forms fusing layer (A) and at least one staple fiber nonwoven or, as an alternative, one staple fiber nonwoven fabric, forms layer (B).

Layer (A) and layer (B) can be provided simultaneously or consecutively.

In order to bond fusing layer (A) to layer (B), the layers are combined and bonded. The bonding can be done by means of thermal, water-jet, mechanical, chemical, ultrasound or laser treatment methods. These methods can be combined as desired.

In order to bond (C) layers (A) and (B) together, no additional melt adhesive or components are used that—during the adhesion to textile substrates under the normal fusing conditions, that is to say, temperatures up to 200° C., a fusing time of 5 seconds to 120 seconds, a pressure of 0 N/m² to 8×10⁵ N/m²—become active as an adhesive vis-à-vis the textile substrate and result in a measurable adhesion/delamination force, as measured according to DIN 54310:1980. This has the advantage that the complexity and costs of the method are reduced, since there is no need for an additional application unit for the melt adhesive, and the error sources associated with the irregular application of the melt adhesive and quality problems of the fusing interlining are eliminated. Moreover, an additional application of melt adhesive would lead to higher maximum tensile forces and a stiff hand, which is not desired in many of the applications that use fusing interlining.

Surprisingly, when specially adapted conditions are employed with the known methods, layers (A) and (B) can be bonded together in such a way that few or no fibers of fusing layer (A) show through on layer (B). This holds true even for the smallest possible weight per unit area of layer (B) and the maximum possible weight per unit area of layer (A), as well as for all of the claimed bonding methods. The person skilled in the art can easily find the method parameters required for this purpose.

The method for bonding the layers and/or, if applicable, subsequent after-treatments have to be fundamentally carried out in such a way as to prevent excessive shrinkage of the thermoplastic fibers of layer (A) during the fusing of the interlining material, since this would lead to irregularity of the fused area, for example, wave formation, and this is surprisingly achieved.

A thermal treatment is generally carried out in such a way that the staple fibers of layer (B) and/or (A) soften and/or melt at least partially. In this manner, the staple fiber nonwoven is thermoplastically glued. The thermal methods are to be carried out in such a way that the heated parts of the bonding aggregates that come into contact with layers (A) or (B) do not become clogged with melted fibers, which would be detrimental to the uniformity of layer (A) and would cause bonding flaws or tearing of the textile fabric. Surprisingly, this is achieved even when layers (A) and (B) have low weight per unit areas, and even when at least one calendaring roller is heated to temperatures far above the melting and/or softening temperature of the staple fibers of layer (A) that melt at very low temperatures, a phenomenon which is totally amazing to the person skilled in the art. With some copolyamide fibers, the accumulation of melted fiber residues on the calendaring rollers in the upper melting temperature range is even less than in the lower temperature range, which is likewise not what would have been expected. Depending on the extent of the treatment, the structure of the staple fiber nonwoven and of the fibers is either retained or lost after layers (A) and (B) have been bonded together.

In a preferred embodiment, one or more dry-laid staple fiber nonwovens of layer (B) are combined with one or more staple fiber nonwovens of fusing layer (A) and bonded to said fusing layer (A) by means of a calendar comprising, for instance, a heated embossing roller and a heated smoothing roller. The embossing roller is preferably brought into contact with layer (B). The temperature of the embossing roller and of the smoothing roller is selected in each case in such a way that the staple fibers of layer (B) and layer (A) soften at least partially. This is achieved in that an exceptionally pronounced temperature gradient is established between the rollers, such that the roller that is in contact with side B is heated at a much higher temperature than the roller that is in contact with side A. Such a pronounced temperature gradient is not common in the standard methods according to state of the art. After the two sides have been bonded together, they can usually be visually and haptically distinguished, especially due to a different degree of incorporation of the fibers on the fusing side and on the non-fusing side, or due to hardening of the fibers on the fusing side.

In another preferred embodiment, one or more dry-laid staple fiber nonwovens, comprising 80% to 100% by weight of staple fibers having a softening and melting temperature or, if no such temperature is applicable, having a degradation temperature that is higher than or equal to 170° C., are bonded by means of a calendar comprising a heated embossing roller and a heated smoothing roller, in order to form a nonwoven that constitutes layer (B). The conditions of the thermal bonding can be set by means of the pressure, exposure time and temperature in such a way that the staple fibers of layer (B) soften at least partially and are bonded to form the nonwoven. If applicable, the nonwoven thus obtained (layer (B)) is finished without the use of melt adhesives and/or it is dyed by means of methods known to the person skilled in the art and then combined with one or more staple fiber nonwovens of fusing layer (A). Layers (A) and (B) are bonded together by means of a calendar comprising a heated embossing roller and a heated smoothing roller that preferably come into contact with layer (A). For this purpose, a strong temperature gradient is established between the rollers, such that the roller that is in contact with side B is heated at a much higher temperature than the roller that is in contact with side A. After the layers have been bonded together, the two sides of the nonwoven can usually be visually and haptically distinguished, for example, due to a different degree of incorporation of the fibers on the fusing side and on the non-fusing side, or due to a different color of the sides.

Layers (A) and (B), however, can also be bonded together without such a thermoplastic adhesion of the staple fibers, for example, by means of a water-jet treatment, by a mechanical dry-needling process, or by adhesion with a binder (chemical treatment). According to an embodiment of the invention, in the latter case, the only binders that can be used are those that do not have an adhesive effect after they have been applied and dried on the fusing interlining during the thermal fusion to the textile substrate and that, as measured according to DIN 54310:1980, result in a measurable adhesion/delamination force vis-à-vis the textile substrate.

If fusing layer (A) is bonded to layer (B) by means of water jet bonding, then the method is preferably carried out in such a way that layer (B) is the first water jet needling side, and a higher pressure is exerted onto layer (B) than onto layer (A). Since the fibers of fusing layer (A) are incorporated to a lesser degree, the fusing layer (A) has less wear resistance and thus greater fluffiness and a softer hand, and consequently, it can be visually and haptically distinguished from layer (B).

If fusing layer (A) is bonded to layer (B) by means of a needling process, then layer (A) and layer (B) are laid on top of each other and fed through a needling machine. In order to transfer the smallest possible number of fibers of fusing layer (A) onto layer (B), the needling is preferably carried out on one side, with layer (B) being the needling side, and needles with only slightly shaped barbs or with no barbs at all are used.

If fusing layer (A) is chemically bonded to layer (B), then the binder, which optionally contains additional additives such as pigments, is preferably sprayed on by means of the commonly employed methods or else applied onto the width of fabric in the form of a foam. Regarding the binders and additives that can be used, the one limitation is that, in general, the only binders and additives that can be used are those that, during the thermal fusion to the textile substrates and after the application and condensation/drying, do not cause the thus produced fusing interlining to have an adhesive effect on the nonwoven. In order to bond layers (A) and (B) together, the width of fabric containing the binder is preferably passed through a heated aggregate, for example, a dryer. In this process, the temperature has to be set in such a way that drying and, if applicable, condensation of the binder takes place, resulting in bonding to the nonwoven. Preferably, the drying is carried out by a continuous suction dryer whose temperature is set in such a way that the staple fibers of layer (A) can also soften and/or melt partially. When conveyor dryers are used, the fabric is preferably fed in such a way that layer (B) lies on the belt of the dryer. Other aggregates such as, for example, microwave dryers, can also be used for the drying procedure.

In another preferred embodiment, the binder is a UV-cross-linkable binder. Preferred UV-cross-linkable binders include polyester (meth)acrylates, polyurethane (meth)acrylates, polyether (meth)acrylates, optionally with the addition of small amounts of reactive diluents such as styrene, mono-, di-, tri- or tetra-functional acrylates and/or photoinitiators such as azo-bis-isobutyl nitrile, benzophenone, α-hydroxyalkyl phenone. The binder is applied or sprayed as a foam onto the width of fabric, but preferably on both sides, by means of known methods, and cross-linked using one or more UV lamps.

If fusing layer (A) is bonded to layer (B) by means of an ultrasound treatment, the method is carried out in such a way that the staple fibers of layer (B) and/or (A) soften and/or melt at least partially. In this process, the roller of the ultrasound calendar, which is preferably an embossing roller, comes into contact with layer (B).

The bonding methods can be combined with each other as desired.

In general, additional treatment methods can be used after layers (A) and (B) have been bonded.

With these treatment methods as well, no additional melt adhesive or components are used that—during the adhesion to textile substrates under the normal fusing conditions, that is to say, temperatures up to 200° C., a fusing time of 5 seconds to 120 seconds, a pressure of 0 N/m² to 8×10⁵ N/m²—become active as an adhesive and result in a measurable adhesion/delamination force vis-à-vis the textile substrate, as measured according to DIN 54310:1980.

According to another preferred embodiment of the invention, additional treatment steps are provided subsequent to the bonding (C) of layers (A) and (B), and they make it possible to visually and haptically clearly distinguish sides (A) and (B) of the fusing interlining according to the invention.

According to another preferred embodiment, the treatment steps lead to a further bonding of the nonwoven.

The treatment steps also lead to the stabilization of layer (A), if this did not already occur during the bonding of layers (A) and (B), thereby preventing more pronounced shrinkage of the staple fibers during the fusing of the interlining, which would lead to irregularities on the outside of the fused textile substrate.

Suitable treatment steps that can be used include mechanical, chemical, thermal, laser, ultrasound or pressure methods.

A suitable mechanical method for further treatment of the bonded layers (A) and (B) and for making a visual and/or haptic distinction, and, if applicable, for achieving a further bonding of the nonwoven and a stabilization of layer (A) is, for example, mechanical embossing that can be carried out on one side or on both sides without exposure to temperature, and that, if applicable, can lead to a different structuring of the sides.

Suitable thermal methods for making a visual and/or haptic distinction and, if applicable, for achieving a further bonding of the nonwoven and stabilization of layer (A) include, for example, thermal calendaring employing embossing and/or smoothing rollers (thermobonding), heat application (in ovens with a metal belt having a mesh, screen or other structure), or an IR treatment.

In a preferred embodiment, after layers (A) and (B) have been bonded together by means of a calendar or a smoothing apparatus equipped with heated rollers, the nonwoven that has preferably been obtained by means of thermal, mechanical, water-jet or chemical treatment undergoes thermal smoothing. The smoothing is carried out in such a way that the fiber component of layer (A) with the lowest melting temperature is softened and/or melted. This process does not reach the melting, softening or degradation temperature of the fibers that melt at a higher temperature. This results in a stabilization and a smoothing of layer (A) as well as a better visual and haptic distinction of sides (A) and (B).

Preference is also given to a treatment in which, after layers (A) and (B) have been bonded together, the nonwoven that has preferably been obtained by means of thermal, mechanical, water jet or chemical treatment undergoes a hot-air or IR treatment. The temperature of the treatment is selected in such a way that the fiber component of layer (A) with the lowest melting temperature is softened and/or melted. This process does not reach the melting, softening or degradation temperature of the fibers that melt at a higher temperature. This results in a further bonding of layer (A) as well as, due to hardening of said layer, in a stabilization and additional haptic distinction from layer (B).

Like with the thermal treatment methods for bonding layers (A) and (B), it is surprising that, with thermal after-treatment methods, the heated parts of the bonding aggregates that come into contact with layers (A) and (B) such as, for instance, the calendaring rollers, do not become clogged with melted fibers when the conditions are optimally set. Surprisingly, these problems do not occur, even when a component of the bonding aggregate, for example, a calendaring roller, is heated to temperatures above the melting and/or softening temperature of the staple fibers of layer (A) that have the lowest melting temperature.

Suitable chemical methods for achieving a visual and/or haptic distinction and, if applicable, for achieving a further bonding of the nonwoven and stabilization of layer (A) include, for example, spreading or printing. The chemical methods can be carried out without or without the use of binders. In general, chemical methods only make use of those chemicals (e.g. binders, soft finishes) that, after being applied and dried on the fusing interlining, do not develop any adhesive properties vis-à-vis the textile substrate and do not act as melt adhesives during the thermal fusion.

As far as printing methods are concerned, all known methods such as letterpress printing or stamp printing (e.g. relief printing), intaglio printing (e.g. Rouleaux printing), film printing/silk screen printing (e.g. flat screen printing, rotary screen printing), and transfer printing can be used.

In another preferred embodiment, the nonwoven that has preferably been obtained by means of thermal, mechanical, water-jet, chemical, ultrasound or laser treatment is printed on at least one edge after layers (A) and (B) have been bonded together. For example, by means of one or more rotary stamp systems, a water-based or solvent-based dye or a mixture of several dyes is printed on, and these then dry onto the fabric after the water or solvent has evaporated.

The hand properties of the interlining materials can be flexibly adjusted on the basis of the content of homopolymer or copolymer staple fibers and the content of thermoplastic fibers in layer (A), on the basis of the possibility of combining/blending numerous different types of fibers in the staple fiber nonwovens, as well as on the basis of the fiber orientation. In the case of interlining nonwovens that are thermally bonded by means of calendaring, there are additional possibilities for adjusting the hand on the basis of the structure of the embossing roller and the resultant fusion surface of the nonwoven.

The fusing interlinings according to an embodiment of the invention are characterized in that, in addition to the thermoplastic staple fibers, they do not contain any other active or activatable adhesive polymers that act as an adhesive when the interlining is glued onto other textile substrates.

When the fusing interlinings are being fused to suitable textile substrates under the normal fusing conditions, they are characterized by good adhesive strength values of more than 3 N, as measured according to DIN 54310:1980, with deviations in the sample size (test sample: 150 mm×50 mm, test material: 160 mm×60 mm) and a drawing-off speed of 150 mm/min, using a fusing press of the type Kannegiesser CX 1000 or Gygli Top Fusing Mod. PR 5/70, as well as by a durable adhesion, even after a care treatment in the form of laundering once at 60° C.

If applicable, a low level of back-tacking is achieved during the fusion with suitable textile substrates under normal fusing conditions.

The fusing interlinings are especially well-suited for thin textile substrates and those with an interrupted/perforated material structure, since they result in a visually and haptically uniform surface on the outside of the fused textile substrate, and the fusing takes place under optimally set conditions without any melt adhesive soaking through.

It is easy to visually ascertain whether melt adhesive is soaking through to the outside of the textile substrate by observing the color difference between the melt adhesive and the shell fabric. If applicable, for purposes of better recognition, a textile substrate (shell fabric) can be used that is dyed in a color that contrasts with the melt adhesive. Thus, a black shell fabric is the most suitable for recognizing a white melt adhesive that might be soaking through.

On the other hand, it is also possible to add colorants such as pigments to the melt adhesive, and the color of these pigments forms a contrast to the color of the textile. The contrast resulting on the outside of the fused textile substrate due to melt adhesive soaking through can be quantitatively evaluated, for example, by means of image-processing programs, after the digital imaging.

The method according to embodiments of the invention cuts down on waste since there is no need for the melt adhesive coating that is associated with a high reject rate in the conventional production of interlining nonwovens. Consequently, the number of adhesion flaws is reduced, as a result of which fewer rejects have to be discarded. Even more waste is prevented since, due to the elimination of the melt adhesive coating step, there are no process-related rejects that are created when the weight of the melt adhesive application is adjusted every time the production is started up.

Since the method according to embodiments of the invention allows the production of fusing interlinings using conventional installations for the production of staple fiber nonwovens without additional coating or laminating aggregates, thermally fusible interlining nonwovens can be produced economically, with little waste and using few resources.

### Particular Embodiments

The maximum tensile forces are measured in the lengthwise direction (=running direction of the cloth in nonwoven production) according to DIN EN 29073-03:1992, with deviations in the drawing-off speed (200 mm/min).

The delamination forces of the nonwovens are measured according to DIN 54310:1980, with deviations in the sample size (test sample: 150 mm×50 mm, test material: 160 mm×60 mm) and a drawing-off speed of 150 mm/min, using a fusing press of the type Kannegiesser CX 1000 or Gygli Top Fusing Mod. PR 5/70.

The delamination force after laundering is measured according to DIN 54310:1980, with deviations in the sample size (test sample: 150 mm×50 mm, test material: 160 mm×60 mm) and a drawing-off speed of 150 mm/min, using a fusing press of the type Kannegiesser CX 1000 or Gygli Top Fusing Mod. PR 5/70 after one household laundering cycle according to EN ISO 6330:2000 (method no. 2A, 60° C.).

The back-tacking of the nonwovens is measured according to DIN 54310:1980, with deviations in the sample size (test sample: 300 mm×100 mm, test fabric: 300 mm×110 mm) and a drawing-off speed of 150 mm/min, and a measuring distance of 50 mm, using a fusing press of the type Kannegiesser CX 1000.

The thickness is measured according to DIN EN ISO 9073-2:1995.

In the examples below, dry-laid staple fiber nonwovens were used as fusing layer (A) and dry-laid staple fiber nonwovens fabric or a dry-laid staple fiber nonwoven (Example 6) was used as layer (B).

The staple fiber nonwovens of layers (A) and (B) were produced on separate nonwoven-forming installations (combing machines). The production is carried out by means of methods for nonwoven formation that are known to the person skilled in the art, making use of commercially available combing machines, and the staple fibers in the nonwoven can be oriented lengthwise, crosswise or randomly. The staple fiber nonwovens of layers (A) and (B) were subsequently bonded and, if applicable, further treated.

In Example 6, a dry-laid staple fiber nonwoven fabric was employed as layer (B) that was made from dry-laid staple fiber nonwoven and bonded to form a nonwoven in the manner familiar to the person skilled in the art.

In an embodiment of the method according to the invention, aside from thermoplastic staple fibers, no melt adhesives or other components are used that, during the fusing of the interlining nonwovens, could have an adhesive effect vis-à-vis a textile substrate.

### Example 1

A dry-laid, crosswise drawn staple fiber nonwoven, which is produced on a transverse combing machine, and which has a weight per unit area of 18 g/m² (A) and which consists of 100% by weight of homopolymer polyethylene staple fibers having a denier of 2.8 dtex, a cut length of 60 mm, and which has a melting temperature in the range from 128° C. to 133° C., as measured according to ISO 3146:2002-06, is combined with a dry-laid, crosswise drawn staple fiber nonwoven, which is produced on a second transverse combing machine and which has a weight per unit area of 22 g/m² (B), and also combined with a dry-laid, randomly oriented staple fiber nonwoven, which is produced on a random combing machine and which has a weight per unit area of 10 g/m² (B), each consisting of 100% of homopolymer polyethylene terephthalate staple fibers having a denier of 1.7 dtex, a cut length of 38 mm, and a higher melting temperature in the range from 200° C. to 260° C., and they are then bonded by means of mechanical water-jet bonding. The water-jet bonding is carried out in such a manner that layer (B) is the first water jet needling side, and a higher pressure is exerted onto layer (B) than onto layer (A). Subsequently, the fabric is dried in a dryer at 110° C. Since the fibers of fusing layer (A) are incorporated to a lesser degree, which is associated with greater fluffiness of fusing layer (A), it can be visibly and palpably distinguished from the non-fusing side. Finally, the dry fabric undergoes thermal smoothing in a smoothing apparatus consisting of a steel roller and a rubber-coated roller. The smoothing is carried out at a line pressure (setting value of the calendar) of 60 N/mm and at a temperature of 90° C. on the rubber-coated roller and of 130° C. on the steel roller. After the treatment, fusing layer (A) is much smoother than the non-fusing side, as a result of which the fusing layer (A) can be visually and haptically distinguished even more clearly from the non-fusing side than before.

### Example 2

A dry-laid, randomly oriented staple fiber nonwoven, which is produced on a random combing machine and which has a weight per unit area of 12 g/m² (A), and which consists of 100% by weight of homopolymer polyethylene staple fibers having a denier of 7 dtex, a cut length of 60 mm, and a melting temperature in the range from 127° C. to 132° C. (ISO 3146:2002-06), is combined with a dry-laid, randomly oriented staple fiber nonwoven, which is produced on a second random combing machine and which has a weight per unit area of 24 g/m² (B), and which consists of 95% of homopolymer polyethylene terephthalate staple fibers having a denier of 1.7 dtex, a cut length of 38 mm, and a higher melting temperature in the range from 200° C. to 260° C., and of 5% of polyethylene staple fibers having a denier of 2.8 dtex, a cut length of 60 mm, and a melting temperature in the range from 128° C. to 133° C., and they are then bonded by means of mechanical water-jet bonding. The water-jet bonding is carried out in such a manner that layer (B) is the first water-jet needling side, and a higher pressure is exerted onto layer (B) than onto layer (A). After the water-jet bonding, the nonwoven thus obtained is fed in its moist state through a calendar equipped with a smooth steel roller and an embossed steel roller, and it is vented, that is to say, slightly structured without pressure at 126° C., a process in which layer (B), which is in contact with the embossing roller, acquires a visibly more pronounced structuring. Subsequently, the width of fabric is dried in a dryer at 110° C. and subsequently rolled up.

### Example 3

A dry-laid, randomly oriented staple fiber nonwoven, which is produced on a random combing machine and which has a weight per unit area of 24 g/m² (A), and which consists of 100% by weight of homopolymer polyethylene staple fibers having a denier of 2.8 dtex, a cut length of 60 mm, and a melting temperature in the range from 128° C. to 133° C. (ISO 3146:2002-06), is combined with a dry-laid, crosswise drawn staple fiber nonwoven, which is produced on a transverse combing machine and which has a weight per unit area of 40 g/m² (B), and which consists of 100% of homopolymer polyethylene terephthalate staple fibers having a denier of 1.7 dtex, a cut length of 38 mm, and a higher melting temperature in the range from 200° C. to 260° C., and they are then bonded by means of mechanical water-jet bonding. The water-jet bonding is carried out in such a manner that layer (B) is the first water-jet needling side, and a higher pressure is exerted onto layer (B) than onto layer (A). Subsequently, the fabric is dried in a dryer at 110° C. Subsequently, a solvent-based dye is printed onto the edge of the non-fusing side by means of a stamp system and then dried onto the fabric.

### Comparative Example 3A

A dry-laid staple fiber nonwoven made of polyester staple fibers with a weight per unit area of 40 g/m² is water jet bonded and subsequently coated with 24 g/m² of melt adhesive using the powder-dot method.

### Example 4

A dry-laid, crosswise drawn staple fiber nonwoven, which is produced on a transverse combing machine and which has a weight per unit area of 35 g/m² (B), and which consists of 100% by weight of homopolymer polyamide-6 staple fibers having a denier of 1.7 dtex, a cut length of 40 mm, and a melting temperature in the range from 210° C. to 220° C., is combined with a dry-laid, randomly oriented staple fiber nonwoven, which is produced on a random combing machine and which has a weight per unit area of 10 g/m² (A), and which consists of 100% by weight of homopolymer polyethylene staple fibers having a denier of 2.8 dtex, a cut length of 60 mm, and a melting temperature in the range from 128° C. to 133° C., and they are then bonded by means of a Nipco calendar equipped with a heated embossing roller and a smoothing roller at a line pressure (setting value of the calendar) of 60 N/mm and at a surface temperature of 195° C. of the embossing roller and at a temperature of 115° C. of the smoothing roller. Since the fibers of layer (A) are incorporated to a considerably lesser degree, this side has softer haptics.

### Example 5

A dry-laid, crosswise drawn staple fiber nonwoven, which is produced on a transverse combing machine and which has a weight per unit area of 40 g/m² (B), and which consists of 100% by weight of homopolymer polyethylene terephthalate staple fibers having a denier of 1.7 dtex, a cut length of 38 mm, and a melting temperature in the range from 200° C. to 260° C., is combined with a dry-laid, randomly oriented staple fiber nonwoven, which is produced on a random combing machine and which has a weight per unit area of 10 g/m² (A), and which consists of 100% by weight of homopolymer polyethylene staple fibers having a denier of 2.8 dtex, a cut length of 60 mm, and a melting temperature in the range from 128° C. to 133° C., they are then bonded by means of a Nipco calendar equipped with a heated embossing roller and a smoothing roller at a line pressure (setting value of the calendar) of 60 N/mm and at a surface temperature of 230° C. of the embossing roller and at a temperature of 116° C. of the smoothing roller. Subsequently, a dye is printed onto the edge of the non-fusing side by means of a rotary stamp system and then dried onto the fabric.

### Comparative Example 5A

A dry-laid staple fiber nonwoven made of polyethylene terephthalate staple fibers with a weight per unit area of 40 g/m² is thermally bonded and subsequently coated with 10 g/m² of melt adhesive using the double-dot method.

### Example 6

A dry-laid, randomly oriented, thermally bonded, staple fiber nonwoven, which is produced on a random combing machine and which has a weight per unit area of 25 g/m² (B), dyed in the color beige, and which consists of 65% by weight of homopolymer polyamide-6 staple fibers having a denier of 1.7 dtex, a cut length of 40 mm, and a melting temperature in the range from 200° C. to 210° C., and of 35% by weight of homopolymer white polyethylene terephthalate staple fibers having a denier of 1.7 dtex, a cut length of 38 mm, and a melting temperature in the range from 200° C. to 260° C., is combined with a dry-laid, randomly oriented staple fiber nonwoven, which is produced on a random combing machine and which has a weight per unit area of 12 g/m² (A), and which consists of 100% of homopolymer white polyethylene staple fibers having a denier of 2.8 dtex, a cut length of 60 mm, and a melting temperature in the range from 128° C. to 133° C., and they are then bonded by means of a Nipco calendar equipped with a heated embossing roller and a smoothing roller, in which the embossing roller at a surface temperature of 195° C. is brought into contact with layer (B), and the smoothing roller at a surface temperature of 115° C. is brought into contact with layer (A) at a line pressure (setting value of the calendar) of 60 N/mm. Due to the color difference, fusing layer (A) and layer (B) can clearly be distinguished from each other visually.

### Example 7

A dry-laid, crosswise randomly oriented staple fiber nonwoven, which is produced on a random combing machine and which has a weight per unit area of 50 g/m² (B), and which consists of 100% by weight of homopolymer polyethylene terephthalate staple fibers having a denier of 1.6 dtex, a cut length of 38 mm, and a melting temperature in the range from 200° C. to 260° C., is bonded by means of a Nipco calendar equipped with a heated embossing roller at a surface temperature of 230° C. and an unheated smoothing roller at a line pressure (setting value of the calendar) of 60 N/mm. The layer (B) thus obtained is then bonded with a dry-laid, randomly oriented staple fiber nonwoven, which is produced on a random combing machine and which has a weight per unit area of 40 g/m² (A), and which consists of 100% of copolymer polyester/copolyester staple fibers with a core-sheath arrangement, and the weight ratio of polyester-to-copolyester in the staple fiber is 50%-to-50%, having a denier of 2.2 dtex, a cut length of 50 mm, and a melting temperature of the lower-melting component of 110° C. to 120° C. (copolyester) in the sheath, and of the other component of 250° C. to 260° C. (polyethylene terephthalate) in the core, and they are then bonded by means of a Nipco calendar equipped with an embossing roller and a smoothing roller at a line pressure (setting value of the calendar) of 60 N/mm and at a surface temperature of 230° C. of the embossing roller and at a temperature of 105° C. of the smoothing roller. Subsequently, a dye is printed onto the edge of the non-fusing side by means of a stamp system and then dried onto the fabric.

### Example 8

A dry-laid, crosswise drawn staple fiber nonwoven, which is produced on a transverse combing machine and which has a weight per unit area of 40 g/m² (B), and which consists of 100% by weight of homopolymer polyethylene terephthalate staple fibers having a denier of 1.7 dtex, a cut length of 38 mm, and a melting temperature in the range from 200° C. to 260° C. is combined with a dry-laid, randomly oriented staple fiber nonwoven, which is produced on a random combing machine and which has a weight per unit area of 10 g/m² (A), and which consists of 100% of homopolymer polyethylene staple fibers having a denier of 2.8 dtex, a cut length of 60 mm, and a melting temperature in the range from 128° C. to 133° C., and they are then bonded by means of a Nipco calendar equipped with a heated embossing roller and a smoothing roller at a line pressure (setting value of the calendar) of 90 N/mm and at a surface temperature of 250° C. of the embossing roller and at a temperature of 132° C. of the smoothing roller. The ability to visually and haptically distinguish the sides is due to the fact that the fibers of fusing layer (A) are incorporated to a lesser degree, which leads to worse abrasion and to an associated greater fluffiness and softer haptics of fusing layer (A) in comparison to the non-fusing side.

### Example 9

A dry-laid, crosswise drawn staple fiber nonwoven, which is produced on a transverse combing machine and which has a weight per unit area of 23 g/m² (B), and which consists of 50% of homopolymer polyethylene terephthalate staple fibers having a denier of 1.7 dtex, a cut length of 38 mm, and a melting temperature in the range from 200° C. to 260° C., of 25% of viscose having a denier of 1.7 dtex, and a cut length of 40 mm, and of 25% of viscose having a denier of 2.8 dtex, and a cut length of 38 mm is combined with a dry-laid, lengthwise oriented, staple fiber nonwoven, which is produced on a lengthwise combing machine and which has a weight per unit area of 9 g/m² (A) and which consists of 5% of viscose having a denier of 1.7 dtex, and a cut length of 40 mm, and of 95% of polyethylene staple fibers having a denier of 2.8 dtex, a cut length of 60 mm, and a melting temperature in the range from 128° C. to 133° C., and they are impregnated in an impregnating apparatus with the foam of a binder based on an acrylic copolymer with a glass transition temperature T_{g} of −30. The application of the binder amounts to 7 g/m² after it has dried. The width of fabric is subsequently dried in a dryer at 120° C. Then the fabric is fed through a smoothing apparatus with two heated rollers and a smoothed. The temperature of the smoothing roller that is in contact with side B is 180° C., while the temperature of the smoothing roller that comes into contact with side A is 115° C. The two sides of the resulting fusing interlining can be readily distinguished from each other by their different fiber orientation, surface smoothness and sheen.

### Example 10

A dry-laid, crosswise drawn staple fiber nonwoven, which is produced on a transverse combing machine and which has a weight per unit area of 75 g/m² (B), and which consists of 20% of homopolymer polyethylene terephthalate staple fibers having a denier of 3.3 dtex, a cut length of 60 mm, and a melting temperature in the range from 200° C. to 260° C., of 10% of copolymer staple fibers with a core/sheath structure made up of polyethylene terephthalate and modified polyethylene, whereby the weight ratio of polyethylene terephthalate to modified polyethylene in the staple fiber is 50% to 50%, having a denier of 3.0 dtex, a cut length of 50 mm, and a melting temperature in the range from 110° C. to 130° C. (modified polyethylene) in the sheath and of 250° C. to 260° C. (polyethylene terephthalate) in the core, and of 70% of viscose having a denier of 1.7 dtex, and a cut length of 40 mm, is combined with a dry-laid, randomly oriented staple fiber nonwoven, which is produced on a random combing machine and which has a weight per unit area of 25 g/m² (A), and which consists of 100% of homopolymer polyethylene staple fibers having a denier of 2.8 dtex, a cut length of 60 mm, and a melting temperature in the range from 128° C. to 133° C., and they are mechanically needled and fed through a dryer with a dryer setting temperature of 131° C., in such a way that (B) lies on the belt of the dryer. Subsequently, the width of fabric is smoothed on a heated smoothing apparatus with two steel rollers at 105° C. and at a line pressure (setting value of the calendar) of 13 N/mm on one side of fusing layer (A). After this treatment, fusing layer (A) is much smoother and thus can thus be haptically distinguished from the non-fusing side.

### Example 11

A dry-laid, crosswise drawn staple fiber nonwoven, which is produced on a transverse combing machine and which has a weight per unit area of 40 g/m² (B), and which consists of 100% by weight of homopolymer polyethylene terephthalate staple fibers having a denier of 1.7 dtex, a cut length of 38 mm, and a melting temperature in the range from 250° C. to 260° C., is combined with a dry-laid, randomly oriented staple fiber nonwoven, which is produced on a random combing machine and which has a weight per unit area of 15 g/m² (A), and which consists of 100% of homopolymer copolyamide staple fibers having a denier of 3.3 dtex, a cut length of 51 mm, and a melting temperature in the range from 75° C. to 135° C., and they are then bonded by means of a Nipco calendar equipped with a heated embossing roller and a smoothing roller at a line pressure (setting value of the calendar) of 60 N/mm and at a surface temperature of 232° C. of the embossing roller and at a temperature of 110° C. of the smoothing roller. After the fusing side (A) has been bonded, it is characterized by a higher sheen, a smoother hand and better abrasion value in comparison to layer (B), as a result of which the two sides can be very readily distinguished from each other.

### Comparative Example 11A

A dry-laid staple fiber nonwoven made of polyethylene terephthalate staple fibers with a weight per unit area of 40 g/m² is thermally bonded and subsequently coated with 15 g/m² of melt adhesive using the paste-dot method.

### Example 12

The fusing interlinings produced according to Examples 1 to 11 were bonded to textile substrates. Depending on the fusing interlining employed, the bonding step was carried out under heat and pressure conditions for 12 or 15 seconds. Cotton or else 65% cotton and 35% polyester was used as the substrate.

The precise conditions, test materials and results can be found in Tables 1 and 2.

TABLE 1
Maximum tensile force

| | | | | MTF length- | | |
|---|---|---|---|---|---|---|
| | | Fusing through- | | wise/N com- | | |
| | MTF length- | feed pressing | Test material | bination of | | |
| | wise/N | machine | fiber compo- | test material/ | DF/N | DF/N after |
| Fusing | interlining | temperature/ | sition, weight, | interlining | primary | laundering |
| interlining | non-woven | pressure/time | thickness | nonwoven | adhesion | once at 60° C. |
| Example 1 | 100.04 | 140° C./170° C., | 100% CO, 150 | 618.04 | 3.5 | 4.5 |
| | | 1.5 × 10⁵ N/m², | g/m², 0.32 mm | | | |
| | | 15 sec, Gygli Top | | | | |
| | | Fusing Mod. PR | | | | |
| | | 5/70 | | | | |
| Example 2 | 3.45 | 140° C./170° C., | 100% CO, 150 | 554.43 | 5.0 | 12.6 |
| | | 1.5 × 10⁵ N/m², | g/m², 0.32 mm | | | |
| | | 15 sec, Gygli Top | | | | |
| | | Fusing Mod. PR | | | | |
| | | 5/70 | | | | |
| Example 3 | 8.28 | 140° C./170° C., | 100% CO, 150 | 506.64 | 12.8 | 55.8 |
| | | 1.5 × 10⁵ N/m², | g/m², 0.32 mm | | | |
| | | 15 sec, Gygli Top | | | | |
| | | Fusing Mod. PR | | | | |
| | | 5/70 | | | | |
| Comparative | 89.59 | 140° C./170° C., | 100% CO, 150 | 317.72 | 11.9 | 44.9 |
| example 3A | | 1.5 × 10⁵ N/m², | g/m², 0.32 mm | | | |
| | | 15 sec, Gygli Top | | | | |
| | | Fusing Mod. PR | | | | |
| | | 5/70 | | | | |
| Example 4 | 9.89 | 130° C., 2.5 × 10⁵ | 65% CO/ | 862.14 | 6.9 split | 2.1 split |
| | | N/m², 12 sec, | 35% PES, 175 | | value | value |
| | | Kannegiesser CX | g/m², 0.28 mm | | | |
| | | 1000 | | | | |
| Example 5 | 10.96 | 130° C., 2.5 × 10⁵ | 65% CO/ | 923.40 | 10 split | 3.1 |
| | | N/m², 12 sec, | 35% PES, 175 | | value | |
| | | Kannegiesser CX | g/m², 0.28 mm | | | |
| | | 1000 | | | | |
| Comparative | 20.88 | 130° C., 2.5 × 10⁵ | 65% CO/ | 759.78 | 9 split | 6.9 |
| example 5A | | N/m², 12 sec, | 35% PES, 175 | | value | |
| | | Kannegiesser CX | g/m², 0.28 mm | | | |
| | | 1000 | | | | |
| Example 6 | 12.72 | 130° C., 2.5 × 10⁵ | 65% CO/ | 953.26 | 7.6 split | 8.3 split |
| | | N/m², 12 sec, | 35% PES, 175 | | value | value |
| | | Kannegiesser CX | g/m², 0.28 mm | | | |
| | | 1000 | | | | |
| Example 7 | 37.83 | 140° C./170° C., | 65% CO/ | — | 4.2 | — |
| | | 1.5 × 10⁵ N/m², | 35% PES, 175 | | | |
| | | 15 sec, Gygli Top | g/m², 0.28 mm | | | |
| | | Fusing Mod. PR | | | | |
| | | 5/70 | | | | |
| Example 8 | 7.73 | 135° C., 2.5 × 10⁵ | 100% CO, 150 | 551.54 | 6.5 split | 7.1 split |
| | | N/m², 12 sec, | g/m², 0.32 mm | | value | value |
| | | Kannegiesser CX | | | | |
| | | 1000 | | | | |
| Example 9 | 35.46 | 130° C., 2.5 × 10⁵ | 65% CO/ | — | 3.8 | — |
| | | N/m², 12 sec, | 35% PES, 175 | | | |
| | | Kannegiesser CX | g/m², 0.28 mm | | | |
| | | 1000 | | | | |
| Example 10 | 110.00 | 140° C., 2.5 × 10⁵ | 65% CO/ | — | 6.2 | — |
| | | N/m², 12 sec, | 35% PES, 175 | | | |
| | | Kannegiesser CX | g/m², 0.28 mm | | | |
| | | 1000 | | | | |
| Example 11 | 15.14 | 120° C., 2.5 × 10⁵ | 100% CO, 123 | 864.72 | 7.8 split | 3.0 |
| | | N/m², 12 sec, | g/m², 0.25 mm | | value | |
| | | Kannegiesser CX | | | | |
| | | 1000 | | | | |
| Comparative | 22.81 | 120° C., 2.5 × 10⁵ | 100% CO, 123 | 880.04 | 6.4 split | 10.1 split |
| example | | N/m², 12 sec, | g/m², 0.25 mm | | value | value |
| 11A | | Kannegiesser CX | | | | |
| | | 1000 | | | | |
| Example 12 | 15.14 | 120° C., 2.5 × 10⁵ | 100% CO, 20 g/m², | 179.30 | 10.1 | 7.0 |
| | | N/m², 12 sec, | 0.13 mm | | | |
| | | Kannegiesser CX | | | | |
| | | 1000 | | | | |
| Comparative | 22.81 | 120° C., 2.5 × 10⁵ | 100% PES, 20 g/m², | 205.51 | 14.4 split | 9.1 split |
| example | | N/m², 12 sec, | 0.13 mm | | value | value |
| 12A | | Kannegiesser CX | | | | |
| | | 1000 | | | | |

Abbreviations:
MTF = maximum tensile force in the lengthwise direction
DF = delamination force
CO = cotton
PES = polyethylene terephthalate

TABLE 2
Back-tacking

| | Fusing through-feed | Test material | |
|---|---|---|---|
| Fusing | pressing machine | fiber composition | |
| interlining | temperature/pressure/time | weight, thickness | BT/N |
| Example 1 | 140° C./170° C., | 65% CO/35% PES, | 0.39 |
| | 1.5 × 10⁵ N/m², 15 sec, | 175 g/m², 0.28 mm | |
| | Gygli Top Fusing Mod. | | |
| | PR 5/70 | | |
| Example 2 | 140° C./170° C., | 65% CO/35% PES, | 0.70 |
| | 1.5 × 10⁵ N/m², 15 sec, | 175 g/m², 0.28 mm | |
| | Gygli Top Fusing Mod. | | |
| | PR 5/70 | | |
| Example 3 | 140° C./170° C., | 65% CO/35% PES, | 2.43 |
| | 1.5 × 10⁵ N/m², 15 sec, | 175 g/m², 0.28 mm | |
| | Gygli Top Fusing Mod. | | |
| | PR 5/70 | | |
| Comparative | 140° C./170° C., | 65% CO/35% PES, | 6.87 |
| example 3A | 1.5 × 10⁵ N/m², 15 sec, | 175 g/m², 0.28 mm | |
| | Gygli Top Fusing Mod. | | |
| | PR 5/70 | | |
| Example 4 | 130° C., 2.5 × 10⁵ N/m², | 65% CO/35% PES, | 0 |
| | 15 sec, Kannegiesser CX 1000 | 175 g/m², 0.28 mm | |
| Example 5 | 130° C., 2.5 × 10⁵ N/m², | 65% CO/35% PES, | 0.3 |
| | 12 sec, Kannegiesser CX 1000 | 175 g/m², 0.28 mm | |
| Comparative | 130° C., 2.5 × 10⁵ N/m², | 65% CO/35% PES, | 0.3 |
| example 5A | 12 sec, Kannegiesser CX 1000 | 175 g/m², 0.28 mm | |
| Example 6 | 130° C., 2.5 × 10⁵ N/m², | 65% CO/35% PES, | 0.19 |
| | 12 sec, Kannegiesser CX 1000 | 175 g/m², 0.28 mm | |
| Example 7 | 140° C./170° C., | 65% CO/35% PES, | 0 |
| | 1.5 × 10⁵ N/m², 15 sec, | 175 g/m², 0.28 mm | |
| | Gygli Top Fusing Mod. | | |
| | PR 5/70 | | |
| Example 8 | 135° C., 2.5 × 10⁵ N/m², | 65% CO/35% PES, | 1.67 |
| | 15 sec, Kannegiesser CX 1000 | 175 g/m², 0.28 mm | |
| Example 9 | 130° C., 2.5 × 10⁵ N/m², | 65% CO/35% PES, | 0 |
| | 12 sec, Kannegiesser CX 1000 | 175 g/m², 0.28 mm | |
| Example 10 | 140° C., 2.5 × 10⁵ N/m², | 65% CO/35% PES, | 0 |
| | 12 sec, Kannegiesser CX 1000 | 175 g/m², 0.28 mm | |
| Example 11 | 120° C., 2.5 × 10⁵ N/m², | 100% CO, | 0.06 |
| | 12 sec, Kannegiesser CX 1000 | 123 g/m², 0.25 mm | |
| Comparative | 120° C., 2.5 × 10⁵ N/m², | 100% CO, | 0.1 |
| example 11A | 12 sec | 123 g/m², 0.25 mm | |
| Example 12 | 120° C., 2.5 × 10⁵ N/m², | 100% PES, | 0 |
| | 12 sec, Kannegiesser CX 1000 | 20 g/m², 0.13 mm | |
| Comparative | 120° C., 2.5 × 10⁵ N/m², | 100% PES, | 0.09 |
| example 12A | 12 sec, Kannegiesser CX 1000 | 20 g/m², 0.13 mm | |

Abbreviations: BT = back-tacking

It can also be seen in Table 1 that the interlining nonwovens according to embodiments of the invention are characterized not only by a very good primary adhesion (well above 3 N) but also by an equally good durability of the adhesion (far more than 1 N after laundering once at 60° C.).

Moreover, it can be seen that the maximum tensile forces of the bond consisting of the interlining nonwoven and the shell fabric (=test material), which is a measure of the hand properties of the bond, can be varied over a very wide range from a very soft hand to a very stiff hand.

In a comparison with the comparative examples, which are likewise compiled in the table, it can be seen that the properties of the interlining nonwovens according to embodiments of the invention—although they can be manufactured much more easily and cost-effectively—are in no way inferior to the conventional fusing interlinings.

The same applies in terms of their back-tacking values, as can be seen in Table 2.

The fact that the thermally fusible interlining nonwovens according to the invention can also be used successfully with thin shell fabrics or those with a perforated material structure is clearly shown in the figures.

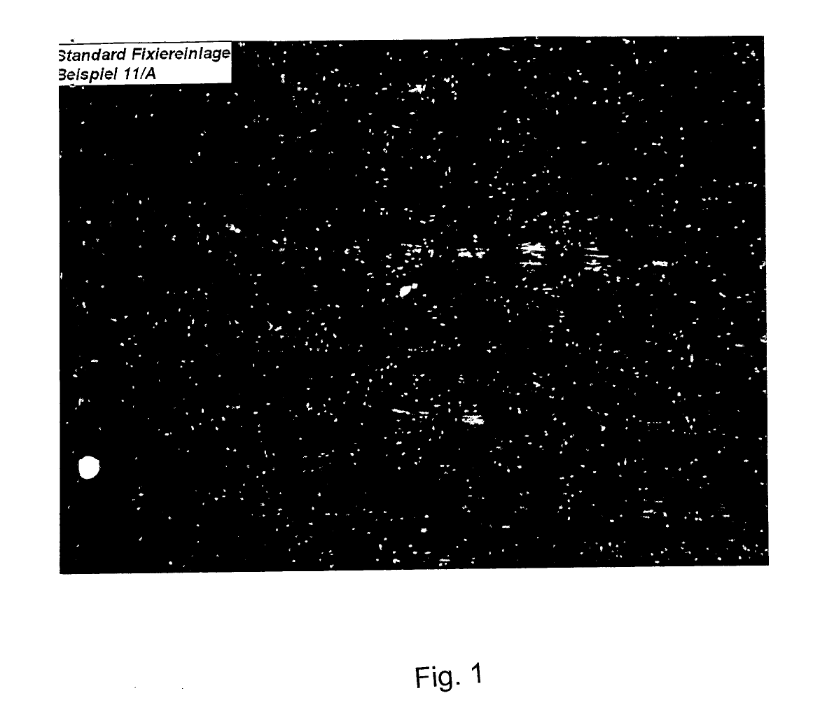

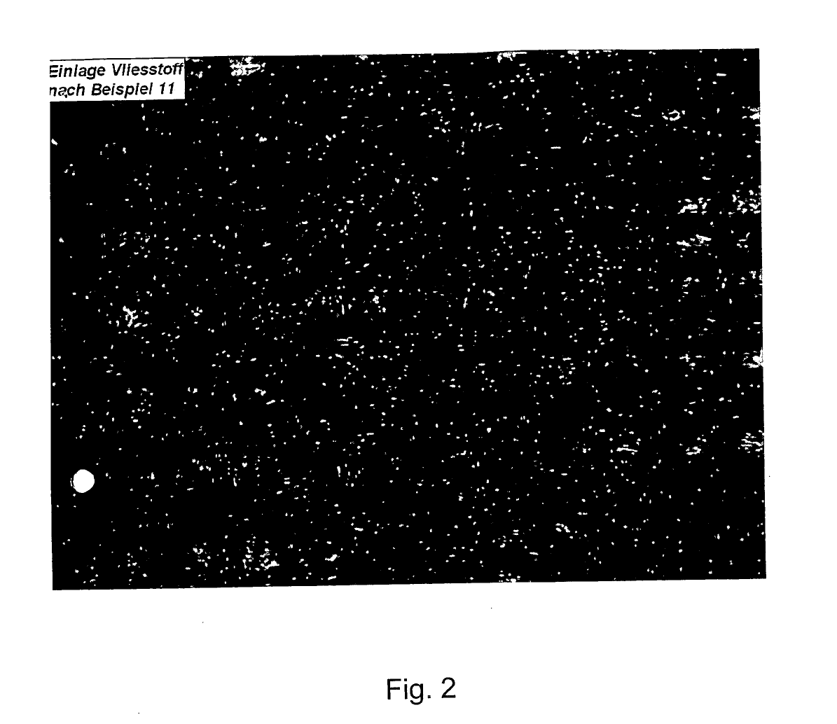

In FIG. 1, one can see a soaked-through melt adhesive dot (circled in red) in the standard nonwoven interlining, while, as can be seen in FIG. 2, the interlining nonwoven according to the invention on the same shell material is characterized by a uniform appearance and feel.

While the invention has been particularly shown and described with reference to preferred embodiments thereof, it will be understood by those skilled in the art that various changes in form and details may be made therein without departing from the spirit and scope of the invention.

1-18. (canceled)

19. A thermally fusible interlining nonwoven comprising:
a fusing layer (A) including at least one staple fiber nonwoven containing at least 50% by weight of thermoplastic staple fibers having at least one of a melting or softening temperature in a range from 60° C. to 165° C.; and
a layer (B) including at least one staple fiber nonwoven or a staple fiber nonwoven fabric including staple fibers, at least 80% by weight of the staple fibers having at least one of a softening temperature, melting temperature and degradation temperature that is higher than or equal to 170° C., layer (B) being bonded together with layer (A).

20. The thermally fusible interlining nonwoven recited in claim 19, wherein the thermoplastic staple fibers are melted.

21. The thermally fusible interlining nonwoven recited in claim 19, wherein the thermoplastic staple fibers are not melted.

22. The thermally fusible interlining nonwoven recited in claim 19, wherein the nonwoven does not include an additional melt adhesive for bonding onto a textile shell fabric.

23. The thermally fusible interlining nonwoven recited in claim 19, wherein the at least one of a melting or softening temperature in a range from 75° C. to 140° C.

24. The thermally fusible interlining nonwoven recited in claim 19, wherein the staple fiber nonwoven of layer (A) has thermoplastic fibers including at least one of copolyamide, polyester, copolyester, polyolefin, polypropylene, polyethylene, polyvinyl acetate, ethylene vinyl acetate, polylactic acid or (ethylene)methacrylic acid.

25. The thermally fusible interlining nonwoven recited in claim 19, the staple fiber nonwoven or the staple fiber nonwoven fabric of layer (B) includes staple fibers including at least one of polyamide, polyester, native cellulose, regenerated cellulose, m-aramid, p-aramid, melamin resin and wool.

26. The thermally fusible interlining nonwoven recited in claim 19, wherein the fusing layer (A) forms 5% to 50% by weight of the fusible interlining.

27. The thermally fusible interlining nonwoven recited in claim 26, wherein the fusing layer (A) forms 10% to 40% by weight of the fusible interlining.

28. The thermally fusible interlining nonwoven recited in claim 27, wherein the fusing layer (A) forms 15% to 35% by weight of the fusible interlining.

29. The thermally fusible interlining nonwoven recited in claim 19, wherein the weight per unit area of the fusing interlining is between 10 g/m² and 300 g/m²

30. The thermally fusible interlining nonwoven recited in claim 29, wherein the weight per unit area of the fusing interlining is between 15 g/m² and 150 g/m².

31. The thermally fusible interlining nonwoven recited in claim 30, wherein the weight per unit area of the fusing interlining is between 20 g/m² and 100 g/m².

32. The thermally fusible interlining nonwoven recited in claim 19, wherein the weight of each of layer (A) and layer (B) is at least 5 g/m².

33. The thermally fusible interlining nonwoven recited in claim 19, wherein the fusible interlining is configured so as to have delamination force values, after fusing to a textile shell fabric under conventional fusing conditions, of at least 3 N, as measured according to DIN 54310:1980, with deviations in the sample size (test sample: 50 mm×150 mm, test material: 60 mm×160 mm) and a drawing-off speed of 150 mm/min, using a fusing press of the type Kannegiesser CX 1000 or Gygli Top Fusing Mod. PR 5/70.

34. The thermally fusible interlining nonwoven recited in claim 19, wherein the thermoplastic staple fibers having at least one of a melting temperature and softening temperature in a range of 60° C. and 165° C. of layer (A) form at least 90% by weight of layer (A).

35. A method of producing a thermally fusible interlining nonwoven comprising:
providing a fusing layer (A) including at least one staple fiber nonwoven containing at least 50% by weight of thermoplastic staple fibers having at least one of a melting or softening temperature in a range from 60° C. to 165° C.;
providing a layer (B) including at least one staple fiber nonwoven or a staple fiber nonwoven fabric including staple fibers, at least 80% by weight of the staple fibers having at least one of a softening temperature, melting temperature and degradation temperature that is higher than or equal to 170° C.; and
bonding fusing layer (A) to layer (B).

36. The method recited in claim 35, wherein the bonding includes at least one of a mechanical treatment, a thermal treatment and a chemical treatment.

37. The method recited in claim 36, wherein the bonding includes the mechanical treatment, and wherein the mechanical treatment is a water-jet treatment or a needling process.

38. The method recited in claim 36, wherein the bonding includes the thermal treatment at a temperature above the melting or softening temperature of the thermoplastic fibers.

39. The method recited in claim 35, wherein the bonding allows visual distinguishing of layer (A) from layer (B).

40. A method of bonding a thermally fusible interlining nonwoven to a textile substrate, the method comprising:
providing a thermally fusible interlining nonwoven including:
a fusing layer (A) including at least one staple fiber nonwoven containing at least 50% by weight of thermoplastic staple fibers having at least one of a melting or softening temperature in a range from 60° C. to 165° C.; and
a layer (B) including at least one staple fiber nonwoven or a staple fiber nonwoven fabric including staple fibers, at least 80% by weight of the staple fibers having at least one of a softening temperature, melting temperature and degradation temperature that is higher than or equal to 170° C., layer (B) being bonded together with layer (A); and
bonding the thermally fusible interlining nonwoven to the textile substrate without the use of an additional melt adhesive by heating the thermally fusible interlining nonwoven to a temperature higher than or equal to the at least one of a melting or softening temperature of the thermoplastic staple fibers of layer (A) and adhering the thermally fusible interlining nonwoven to the textile substrate.

41. The method recited in claim 39, wherein the textile includes at least one of cellulose, regenerated cellulose, wool, polyester and polyamide.

42. A textile formed by bonding a thermally fusible interlining nonwoven to a textile substrate using a method including:
providing a thermally fusible interlining nonwoven including:
a fusing layer (A) including at least one staple fiber nonwoven containing at least 50% by weight of thermoplastic staple fibers having at least one of a melting or softening temperature in a range from 60° C. to 165° C.; and
a layer (B) including at least one staple fiber nonwoven or a staple fiber nonwoven fabric including staple fibers, at least 80% by weight of the staple fibers having at least one of a softening temperature, melting temperature and degradation temperature that is higher than or equal to 170° C., layer (B) being bonded together with layer (A); and
bonding the thermally fusible interlining nonwoven to the textile substrate without the use of an additional melt adhesive by heating the thermally fusible interlining nonwoven to a temperature higher than or equal to the at least one of a melting or softening temperature of the thermoplastic staple fibers of layer (A) and adhering the thermally fusible interlining nonwoven to the textile substrate.

43. The textile recited in claim 2, wherein the textile forms part of an item of clothing, automotive interior upholstery, furniture upholstery, a furniture slipcover, a household textile, a hygiene article or a medical product.
